(19) United States
(12) Patent Application Publication
(10) Pub. No.: US 2007/0071276 A1
(43) Pub. Date: Mar. 29, 2007

(54) Diaphragm for speaker

(76) Inventor: Yoshimi Kudo, Yamagata (JP)

Correspondence Address: YOUNG & THOMPSON, 745 SOUTH 23RD STREET, 2ND FLOOR, ARLINGTON, VA, 22202, US

(21) Appl. No.: 11/523,611

(22) Filed: Sep. 20, 2006

(30) Foreign Application Priority Data
Sep. 22, 2005 (JP) 2005-275908

(51) Int. Cl. H04R 9/06

(52) U.S. Cl. 381/426

(57) ABSTRACT

In a diaphragm for a speaker, a main body part vibrating at a time of driving of a speaker device includes not only a first layer made of a woven fabric and a third layer made of paper, but also a second layer made of metal. The second layer made of the metal, serving as a reinforcement member of the diaphragm, is partly provided within a predetermined range on an inner circumferential side of the main body part. Namely, only the predetermined range on the inner circumferential side has a triple-layer structure having the second layer. Thereby, an inner peripheral part displaced with large amplitude due to large force applied at the time of the driving of the speaker can be effectively reinforced. By reinforcing the inner peripheral part by the metal, strength of the speaker device can be ensured, and sound quality can be improved.

### BACKGROUND OF THE INVENTION

1. Field of the Invention

The present invention relates to a diaphragm used for a speaker device.

2. Description of Related Art

There is known a diaphragm for a speaker, made of a metal material. For example, a diaphragm which is made of metal and partly reinforced by paper is disclosed in Japanese Patent Application Laid-open under No. 2002-78075. In addition, a diaphragm made of magnesium is disclosed in Japanese Patent Application Laid-open under No. 2004-349871.

Meanwhile, a diaphragm for a speaker including a base body mainly made of polypropylene, a part of which or all of which metal or metal compound is disposed to, is disclosed in Japanese Patent Application Laid-open under No. 9-163488. Moreover, a diaphragm for a speaker, in which a whole part or a part of a vibration part has a double structure using an unwoven fabric including a thermoplasticity resin fiber, is disclosed in Japanese Patent Application Laid-open under No. 7-184295.

### SUMMARY OF THE INVENTION

It is an object of this invention to provide a diaphragm for a speaker capable of suppressing weight increase of an entire diaphragm and enhancing strength.

According to one aspect of the present invention, there is provided a diaphragm for a speaker, including a main body part having a lamination structure of a first layer, a second layer made of metal and a third layer, wherein the second layer is partly provided within a predetermined range on an inner circumferential side of the main body part.

In the above diaphragm for the speaker, the main body part vibrating at the time of driving of a speaker device includes not only the first layer and the third layer but also the second layer made of the metal. The second layer made of the metal serves as a reinforcement member of the diaphragm, and it is partly provided within the predetermined range on the inner circumferential side of the main body part. Namely, only the predetermined range on the inner circumferential side has a triple-layer structure including the second layer. Thereby, it becomes possible to effectively reinforce an inner peripheral part displaced with large amplitude by large force applied at the time of the driving of the speaker. By reinforcing the inner peripheral part by the metal, the strength of the diaphragm can be ensured, and sound quality can be improved.

In a preferred manner of the above diaphragm for the speaker, the first layer may be made of a woven fabric and the third layer may be made of paper.

In a manner, the above diaphragm for the speaker may further include a cylindrical fixing part provided at an inner peripheral end of the main body part, and the fixing part may have the lamination structure of the second layer and the third layer. At the inner peripheral end of the main body part, the cylindrical fixing part for fixing the diaphragm to the voice coil bobbin is formed, for example. In this manner, the fixing part has a double-layer structure of the second layer made of the metal and the third layer made of the paper. Thereby, mounting strength of the diaphragm can be ensured, too.

In a manner of the above diaphragm for the speaker, the main body part may have a double-layer structure of the first layer and the third layer on an outer circumferential side of the predetermined range. By providing the second layer made of the metal, strength thereof can be enhanced. However, weight of the entire diaphragm problematically increases. Therefore, there is provided the second layer made of the metal only within the predetermined range on the inner circumferential side, and there is provided the double-layer structure of the first layer and the third layer on the outer circumferential side of it. As a result, it becomes possible to suppress the weight increase of the entire diaphragm at the minimum and effectively enhance the strength of the diaphragm.

In a preferred example, the second layer may be formed between the first layer and the third layer in the main body part. Thereby, since the second layer made of the metal is not exposed to the external, corrosion and peeling of the metal layer can be prevented. The second layer is preferably made of any one of magnesium, aluminum and titanium in order to ensure necessary strength and suppress the weight increase of the diaphragm as much as possible.

In another manner of the above diaphragm for the speaker, the first layer and the third layer may be partly formed. The first layer and the third layer may be partly provided at any portions needed to be reinforced. Thereby, the reinforcement can be performed within an appropriate range for each of the portions needed to be reinforced.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIG. 1 is a plane view and a cross-sectional view schematically showing a configuration of a diaphragm for a speaker according to an embodiment;

FIG. 2 shows an enlarged view showing a lamination structure of the diaphragm for the speaker shown in FIG. 1;

FIG. 3 is a graph showing a characteristic of a speaker device using the diaphragm for the speaker according to the embodiment; and

FIG. 4 is a graph showing a characteristic of a speaker device using a diaphragm for a speaker having no metal layer.

### DETAILED DESCRIPTION OF THE PREFERRED EMBODIMENTS

Now, a preferred embodiment of the present invention will be described below with reference to the attached drawings.

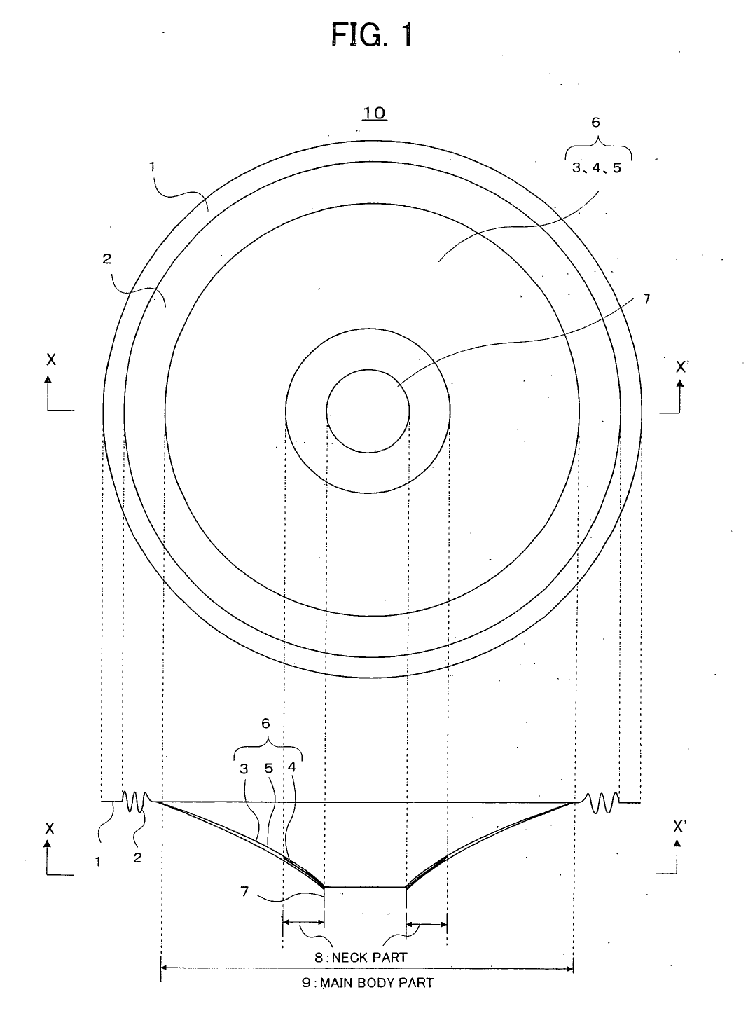

FIG. 1 schematically shows a configuration of the diaphragm for the speaker device (hereinafter simply referred to as “diaphragm”) to which the present invention is applied. In FIG. 1, an upper part is a plane view observed from a sound output side of a diaphragm 10, and a lower part is a cross-sectional view taken along a cutting line X-X′ passing through a center thereof.

As shown in FIG. 1, the diaphragm 10 roughly includes an edge packing 1, an edge 2 and a main body part 9. The edge packing 1 is a part serving as a mounting part at the time of mounting of the diaphragm 10 on a frame of the speaker device. The edge 2, which is provided on an outer peripheral edge of the main body part 9, elastically supports the main body part 9. In this embodiment, the edge 2 is a corrugation edge having a cross-sectional shape formed into plural corrugations. Instead, the edge 2 may be a rolled edge having a cross-sectional shape formed into a substantially semicircle.

The main body part 9 has a vibration part 6 which vibrates in an axis direction (an up-to-down direction at the lower part of FIG. 1) of the speaker device at the time of the driving of the speaker device, and a fixing part 7 formed into a substantially cylindrical shape, which is provided at the inner peripheral end of the main body part 9. The fixing part 7 is a part fixed to the voice coil bobbin at the time of mounting the diaphragm 10 on the voice coil bobbin, for example. Concretely, the cylindrical shape of the fixing part 7 has a diameter slightly larger than the voice coil bobbin, and the fixing part 7 covers a top of the voice coil bobbin to be mounted thereon. In this case, a cylindrical inner peripheral wall of the fixing part 7 is fixed to an outer peripheral wall of the voice coil bobbin via an adhesive.

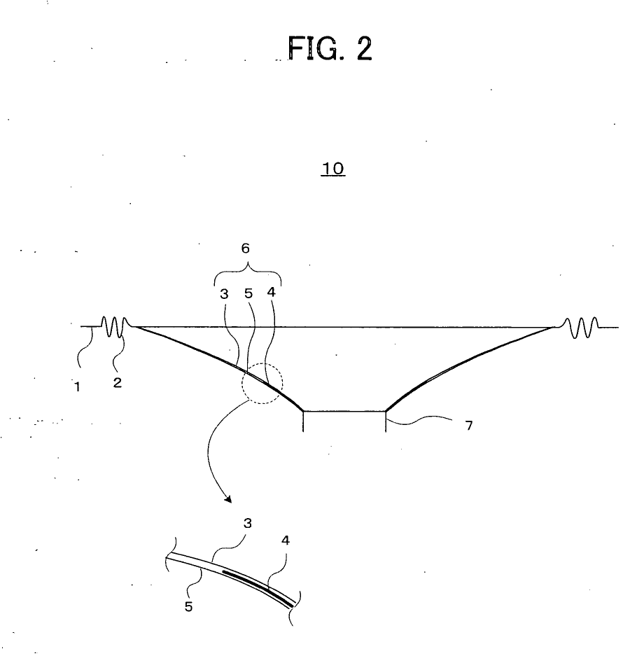

The vibration part 6 has the lamination structure of a woven fabric layer 3, a metal layer 4 and a paper layer 5. The lamination structure of the vibration part 6 is enlarged and shown in FIG. 2. The woven fabric layer 3 serves as a base material of the diaphragm, and a four-axis Kevlar is preferably used therefor. Alternatively, a normal two-axis or three-axis woven fabric may be used. The metal layer 4 serves as a reinforcement member. In this embodiment, the metal layer 4 is provided within a predetermined range on the inner peripheral side of the main body part 9 of the diaphragm 10. Namely, the metal layer 4 is partly provided only on the inner circumferential side, not in the entire area of the main body part 6 of the diaphragm 10.

Generally, the diaphragm is mounted on the voice coil bobbin of the speaker device. When the speaker device is driven, the voice coil bobbin vibrates in the up-to-down direction. Thus, the diaphragm vibrates in accordance with the vibration of the voice coil bobbin. Since the large force is applied to the part for fixing the diaphragm to the voice coil bobbin, i.e., the inner peripheral part of the diaphragm 10, the strength becomes necessary. In this embodiment, the metal layer 4 is provided only within the predetermined range on the inner circumferential side of the vibration part 6 of the diaphragm 10 for the purpose of the reinforcement. In addition, since rigidity can be increased by reinforcing the inner peripheral part of the diaphragm by the metal layer 4, it is advantageous that loss is reduced at the time of the driving of the speaker device and the sound quality is improved.

The vicinity of the inner peripheral end of the diaphragm is generally referred to as “neck part”. In this embodiment, the predetermined range from the inner circumferential side of the diaphragm, i.e., the range within which the metal layer 4 is provided, is referred to as “neck part 8” (see FIG. 1). Thus, the neck part 8 being the area on the inner circumferential side of the main body part 9 has the triple-layer structure having the woven fabric layer 3, the metal layer 4 and the paper layer 5. Meanwhile, the area of the main body part 9, on the outer circumference side of the neck part 8, has the double-layer structure having the woven fabric layer 3 and the paper layer 5.

For the purpose of the reinforcement, the metal layer 4 may be provided at the entire part of the diaphragm 10. However, if so, the weight of the entire diaphragm increases, and driving efficiency of the speaker decreases. Therefore, in this embodiment, only the inner circumferential side most necessary to be reinforced is reinforced by the metal layer 4.

Additionally, in a design step, by appropriately setting the area (area of the neck part 8) in which the metal layer 4 is provided, the strength and weight of the diaphragm can be flexibly set, and desired sound quality can be realized.

As the metal layer 4, light metal with high rigidity is preferable. For example, magnesium, aluminum and titanium are preferable.

Meanwhile, the paper layer 5, which is provided at the entire part of the main body part 9 of the diaphragm 10, has a function to reinforce the entire diaphragm 10. Since the paper layer 5 is light, even if it is provided at the entire part of the main body part 9 of the diaphragm 10, there is no problem of the weight increase of the diaphragm.

Additionally, in this embodiment, the metal layer 4 may be provided at the cylindrical fixing part 7, too. Namely, the cylindrical fixing part 7 may have the double-layer structure of the metal layer 4 and the paper layer 5. Thereby, since the strength of the fixing part 7 is enhanced, the mounting strength of the diaphragm to the voice coil bobbin can be improved.

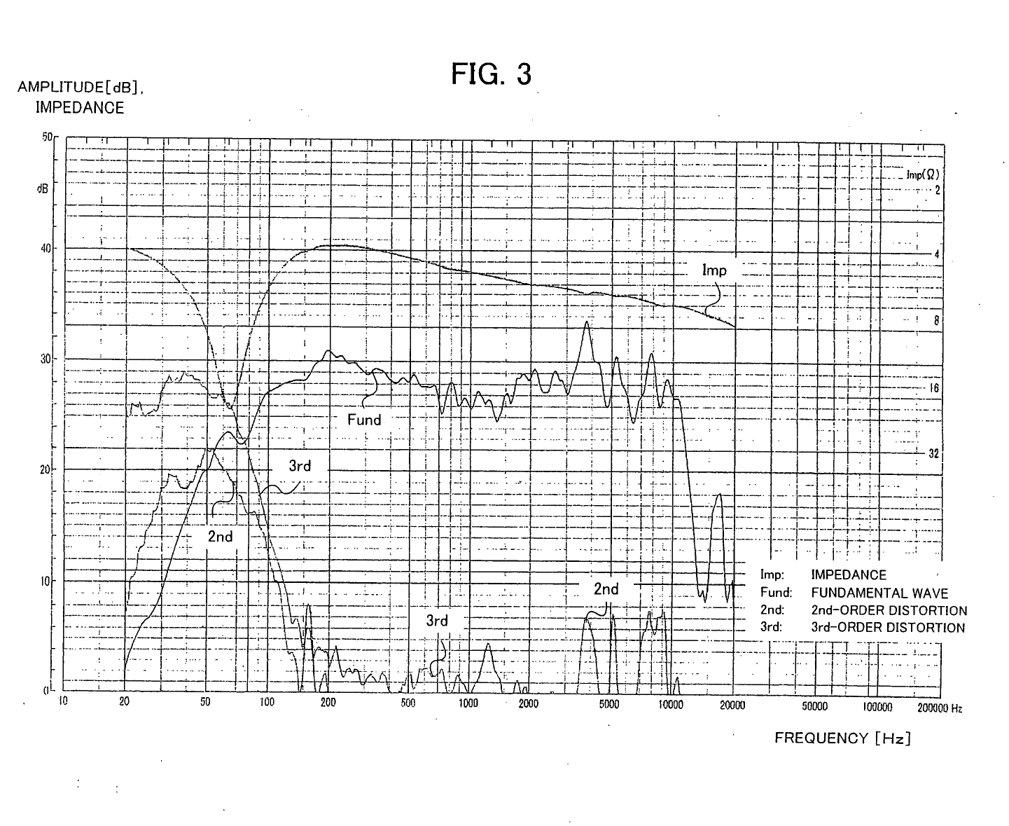

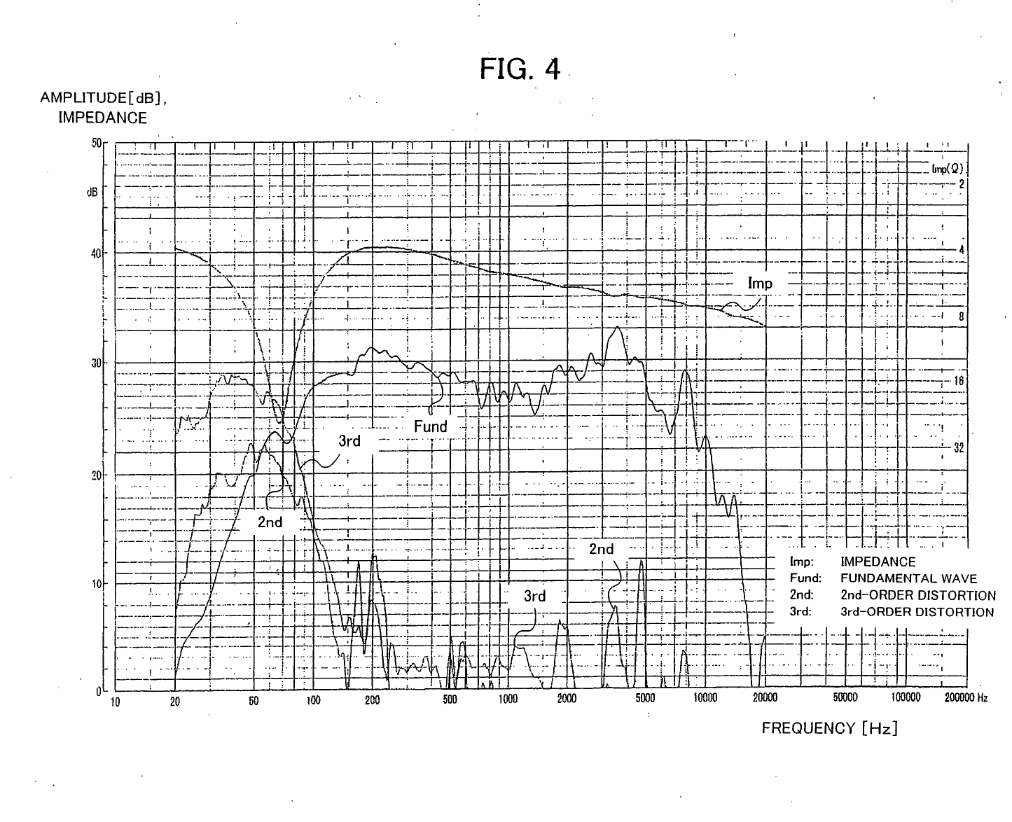

FIG. 3 shows a frequency characteristic of the speaker device using the diaphragm for the speaker according to this embodiment. In addition, as a comparative example, FIG. 4 shows a frequency characteristic of a speaker device which uses the diaphragm similar to the diaphragm for the speaker according to the embodiment, but which does not have a metal layer. Namely, they are different only in that the diaphragm according to the comparative example has no metal layer. As understood by comparing FIG. 3 and FIG. 4, in the speaker device using the diaphragm according to the embodiment, a fundamental wave of a reproduction sound shows the flat frequency characteristic in an audible frequency band of 100 Hz to 20 kHz. In addition, as compared with the speaker device using the diaphragm according to the comparative example, amount of 1st-order distortion and 2nd-order distortion are also decreased.

In a modification of this embodiment, the first layer and the third layer may be partly provided at any optional portion needed to be reinforced. Thereby, the reinforcement can be made within the appropriate range for each part needed to be reinforced.

As described above, in this embodiment, in the diaphragm for the speaker, the vibration part has the lamination structure of the woven fabric layer such as the four-axis Kevlar, the metal layer such as the magnesium, and the paper layer, and the metal layer is formed only at the neck part within the predetermined range from the inner circumferential side of the vibration part. Thereby, it becomes possible that, while the weight increase of the entire diaphragm is suppressed, the necessary strength is ensured and the sound quality is improved.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Application No. 2005-275908 filed on Sep. 22, 2005 including the specification, claims, drawings and summary is incorporated herein by reference in its entirety.

What is claimed is:

1. A diaphragm for a speaker, comprising a main body part including a lamination structure of a first layer, a second layer made of metal and a third layer,
wherein the second layer is partly provided within a predetermined range on an inner circumferential side of the main body part.

2. The diaphragm for the speaker according to claim 1, wherein the first layer is made of a woven fabric and the third layer is made of paper.

3. The diaphragm for the speaker according to claim 1, further comprising a cylindrical fixing part provided at an inner peripheral end of the main body part,
wherein the fixing part has the lamination structure of the second layer and the third layer.

4. The diaphragm for the speaker according to claim 1, wherein the main body part has a double-layer structure of the first layer and the third layer on an outer circumferential side of the predetermined range.

5. The diaphragm for the speaker according to claim 1, wherein the second layer is formed between the first layer and the third layer in the main body part.

6. The diaphragm for the speaker according to claim 1, wherein the first layer and the third layer are partly formed.

7. The diaphragm for the speaker according to claim 1, wherein the second layer is made of any one of magnesium, aluminum and titanium.
